(19) United States
(12) Patent Application Publication
(10) Pub. No.: US 2021/0056516 A1
(43) Pub. Date: Feb. 25, 2021

(54) Compliance management system

(71) Applicant: George Mentis, Austin, TX (US)

(72) Inventor: George Mentis, Austin, TX (US)

(21) Appl. No.: 16/550,179

(22) Filed: Aug. 24, 2019

(51) Int. Cl. G06Q 10/10

(52) U.S. Cl. CPC G06Q 10/1097; G06Q 10/107; G06Q 10/103

(57) ABSTRACT

A generic compliance monitoring system which not only monitors but also ensures compliance. The system is software driven and easily implemented in any hierarchical work or organizational environment where individuals are required to perform tasks either within a predetermined time, or in a specific manner as determined by, e.g. regulations. The system allows for a series of e-mail messages to be transmitted to all members of an organization, with the messages tailored depending upon a user's position within the organization. Entry level or lowest tier users will only get e-mails reminding them of due dates or other specifics. The e-mails at the lowest level will be reminders followed by warnings, the warnings accompanied with increasing consequences if there is continued non-compliance. The next level of user will receive e-mails related to the response of lower tier users, with these e-mails also escalating in urgency and consequence the longer the non-compliance continues. The system ultimately sends an e-mail to the head of the organization in the event of continued non-compliance of one or more users.

### BACKGROUND OF THE INVENTION

### 1. Field of the Invention

The present invention relates to compliance management. More particularly, the present invention relates to a compliance management system, which may optimally be implemented with software.

### 2. Description of the Prior Art

Software driven compliance monitoring systems are well known in the art. The systems are generally menu driven, and can be accessed or displayed on numerous types of electronic devices, these devices interconnected by a network, typically the internet, but in some cases a local or wide area network. The systems tend to be very environmentally specific, with the menu driven presentations displayed on user devices usually related to compliance with one or more tasks, which compliance may be regulation or deadline specific. Also, the system does nothing to address the issue of non-compliance, other than to make the non-compliance apparent to those accessing the system. Accordingly, there is a need for a compliance management system, which both monitors and incentivizes compliance.

Typical of these is the system described in US patent application number 20100023353. It relates to a system and method for tracking and auditing against guidelines and compliance with these guidelines. The system is implemented in a very specific environment. It allows a firm to, in an automatic process, manual process or both, receive notifications of upcoming and passed guideline due dates. It has both prospective and retrospective auditing capabilities. The system is customizable to fit the idiosyncrasies of each user firm, such as client type and billing procedures. In one aspect, the present invention may utilize the industry standard Universal Task Based Management System (UTBMS) task and activity codes, but it is contemplated that other coding systems could be used. In one aspect, the system may utilize a 3rd party time keeping software database package for the regular input of work time performed and various other data inputs, but it is contemplated that this could also be done within the main compliance software package itself. It also sorts and keeps track of email communications as they relate to specific tasks or matters. This type of system cannot be modified to work as a general compliance management system adaptable to virtually any business. Also, this system merely monitors compliance, but does not ensure or force compliance.

Another type of system for compliance management is the reminder system disclosed in U.S. Pat. No. 9,083,663. This type of system is fairly adaptable but is a simple reminder system. Also, it too does not provide any recourse in the event of continued non-compliance.

Accordingly, the present invention is directed to a generic compliance monitoring system which not only monitors but also ensures compliance. The system is software driven and easily implemented in any hierarchical work or organizational environment where individuals are required to perform tasks either within a predetermined time, or in a specific manner as determined by, e.g. regulations. The system allows for a series of e-mail messages to be transmitted to all members of an organization, with the messages tailored depending upon a user's position within the organization. Entry level or lowest tier users will only get e-mails reminding them of due dates or other specifics. The e-mails at the lowest level will be reminders followed by warnings, the warnings accompanied with increasing consequences if there is continued non-compliance. The next level of user will receive e-mails related to the response of lower tier users, with these e-mails also escalating in urgency and consequence the longer the non-compliance continues. The system ultimately sends an e-mail to the head of the organization in the event of continued non-compliance of one or more users. The system may also send e-mails, text messages, or other forms of communication to outside agencies such as holding companies, compliance monitoring law firms, and government agencies.

### SUMMARY OF THE INVENTION

It is a major object of the invention to provide a system for managing compliance.

It is another object of the invention to provide a system for managing compliance which is flexible and can be used in a variety of organizational or work environments.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a diagrammatic representation of the system of the invention.

FIG. 2 shows a chart depicting the method of the invention.

### DETAILED DESCRIPTION OF THE PREFERRED EMBODIMENTS

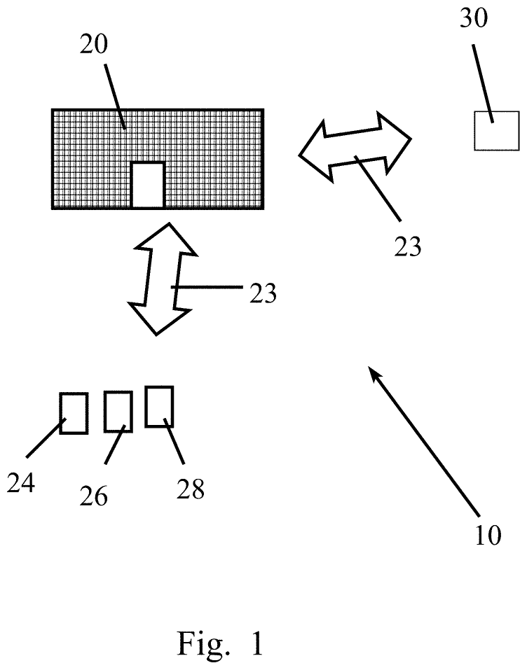

The inventive system, depicted graphically in FIG. 1 and generally designated by the numeral 10, is designed to both monitor and force compliance with any set of rules or regulations, or with any deadlines as may be commonly encountered in a workplace or organizational environment. In the depiction shown in FIG. 1, the organization 20, which is shown as a structure may house many or all of the users of the system 10. Those users may be physically located within the structure or wherever required in order to perform their various duties. Each user is required to have a device for accessing either the internet or some type of computer network 23, this being depicted as a double arrow in FIG. 1. In accordance with a key aspect of the invention, users are given different e-mails depending upon their hierarchy within the system. It should be noted that text alerts, faxes, or any future form of electrical communication may be used in place of e-mails. Also, the primary focus of the system 10 is to force compliance by alerting different levels of users with different messages, with higher level users ultimately pressured to force compliance from their immediate subordinates.

As will be appreciated by one skilled in the art, the inventive method may be embodied as a system 10, method, or computer program product. Accordingly, the method may take the form of an entirely hardware embodiment (where warning e-mails are replaced with other forms of communication such as hard copies of memos on paper), an entirely software embodiment (including firmware, resident software, micro-code, etc.) or an embodiment combining software and hardware aspects that may all generally be referred to herein as a “circuit,” “module” or “system.” Furthermore, the method may take the form of a computer program product embodied in any tangible medium of expression having computer usable program code embodied in the medium. Any combination of one or more computer usable or computer readable medium(s) may be utilized.

Computer program code for carrying out operations of the embodiments of the disclosure may be written in any combination of one or more programming languages. The program code may execute partially on the user's computer or other device, but will primarily be executed on one or more remote servers. The remote server may be connected to the user's computer or device through any type of network, including a local area network (LAN) or a wide area network (WAN), or the connection may be made to an external computer (for example, through the Internet using an Internet Service Provider).

The inventive system 10 functions primarily by sending e-mails to the various users on their respective devices, so that the user devices do no need to have a separate application or software to effect the method. However, an application may be used to implement the system 10 as will be appreciated in the following discussion.

The environment shown in FIG. 1, by way of a non-limiting example, contemplates a 4 tiered organizational hierarchy, with a CEO or organizational head at the top of the hierarchy. Each level of user 24, 26, 28, and 30 receives messaging in the form of e-mails, the content of which is designed to motivate compliance as stated above. As suggested by the FIG. 1, the users may be within or without the structure, the only limitation being that they are all accessible via a network 23 which may be e.g., the internet.

Tier 1 users 24 are, e.g., entry level or junior employees. These users or employees 24 only receive reminders, warnings, and reprimands. They are not authorized to write reports or reprimands, and cannot send out reports or reprimands. Thus, for tier 1 users 24 the system 10 is really just a reminder system. The reminder, warnings, and reprimands are sent via e-mail in accordance with a preferred embodiment, but again other communication means may be used.

Tier 2 users 26 are first level supervisors. The system 10 requires that these users 26 provide reports and reprimands “up the line” while also monitoring the compliance of their subordinates. These users 26 directly interface with users 24 to monitor and incentivize their compliance, and with users 28 to report non-compliance.

The system 10 may also send reports/messages, etc., to e.g., human resources or other higher level personnel, which may order dismissal or other action. In any event, the system 10 can be tailored to meet the needs of a specific client or circumstance.

Tier 3 users 28 are upper level supervisors. The system 10 requires that these users 28 also provide reports and reprimands “up the line” while also monitoring the compliance of their subordinates. These users 28 directly interface with users 26 to monitor and incentivize the compliance of entry level users 24, and with the CEO 30.

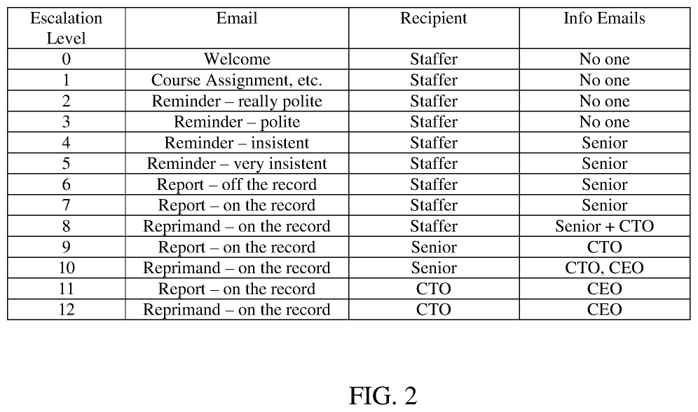

In use, once tasks have been assigned, the system 10 begins to send e-mails to users starting with a welcome e-mail, designated as escalation level 1 followed by an e-mail describing a task to be completed which is designated as escalation level 1. Escalation level 1 is simply a starting designation, at this point the e-mail or other communication is just a description of the task and the due date. Additional warning e-mails are sent to users 24 once a deadline or other requirement is missed, the e-mails escalating in tone (and numeration) in accordance with the chart shown in FIG. 2. If the first warning e-mail does not result in task completion, a second warning e-mail is sent. The third warning e-mail, unlike the first two (escalation levels 2 and 3) is also sent (i.e, copied) to a supervisory user 26 so as to put additional pressure on users 24 to complete the task. The next 3 warning e-mails, escalation levels 5-7 are sent to users 24 and copied to user 26, with e-mails of escalation level 6 and 7 including a report detailing the non-compliance of a specific user 24, which report may be initially off the record at level 6, but on the record at level 7. Level 8 e-mails may include a reprimand and is also sent to supervisory users 26 and 28. Level 8 e-mails may also advise or order termination of employment or other drastic action.

Level 9 and above e-mails are sent to users 26 and above exclusively as shown in FIG. 2. These e-mails are designed to force action from supervisors 26, 28 when users 24 do not comply. Levels 9 and 10 include reports and reprimands, respectively, with level 10 e-mails sent to users 26, 28, and 30. Levels 11 and 12 also include reports and reprimands, respectively, with level 10 e-mails sent to both users 26, 28, and 30. Thus, the system 10 operates to incentivize compliance by continually sending out e-mails (or other communications) to various members of an organization, which escalate in tone and consequence until the task is completed.

It is to be understood that the present invention is not limited to the sole embodiment described above, but encompasses any and all embodiments within the scope of the following claims:

What is claimed is:

1. A method of compliance management among a plurality of users in a hierarchical organization, each of said users having access to electronic messaging via a computer network having instructions stored in at least one storage medium, the method comprising:
a server configured to:
send first and second e-mails to a level one user identifying a task to be completed;
send third and fourth e-mails to said level one users if there is non-compliance with said second e-mail;
send a fifth e-mail to said level one user if there is continued non-compliance, and copying said e-mail to a level two user;
continually send e-mails to users at various levels within said organization until said task is completed.

2. A method of compliance management among a plurality of users in a hierarchical organization, wherein the server is further configured to:
send first and second communications to a level one user identifying a task to be completed;
send third and fourth communications to said level one users if there is noncompliance with said second communications;
send a fifth communications to said level one user if there is continued non-compliance, and copying said communications to a level two user;
continually send communications to users at various levels within said organization until said task is completed.

3. The method of claim 2, wherein said communications are in the form of a text alert.

4. The method of claim 2, wherein said communications are in the form of a hard copy of a letter.
